(19) United States
(12) Patent Application Publication
(10) Pub. No.: US 2012/0122343 A1
(43) Pub. Date: May 17, 2012

(54) Junction box for solar module

(76) Inventor: Dirk Limberg, Werdohl (DE)

(21) Appl. No.: 13/199,831

(22) Filed: Sep. 9, 2011

(30) Foreign Application Priority Data
Sep. 9, 2010 (DE) 10 2010 044 872.9

(51) Int. Cl. H01R 13/66

(52) U.S. Cl. 439/620.21

(57) ABSTRACT

A junction box for a solar module including a housing forming an inner cavity including an end of a connecting conductor for outputting generated electrical energy. The end of the connecting conductor is electrically connected with a module contact and a bypass diode. A lead of the end of the connecting conductor that is included in the housing is provided with a lead end sleeve at which a contact arm of the bypass diode is directly arranged.

### RELATED APPLICATIONS

This patent application claims priority from and incorporates by reference German patent application DE 10 2010 044 872.9 filed on Sep. 9, 2010.

### FIELD OF THE INVENTION

The invention relates to a junction box for a solar module including a housing forming an inner cavity in which an end of a connecting conductor for outputting generated electrical energy is included, wherein the end is electrically connected with a solar module contact and a bypass diode.

### BACKGROUND OF THE INVENTION

A junction box is known from DE 10 2008 049 which advantageously arranges a bypass diode in a cover of a connection diode. The bypass diode is electrically connected with the terminal of the connecting conductor included in the junction box, wherein the connection is provided through metal contact links when the cover is applied to the junction box while the module contacts are simultaneously being fixated.

This particular embodiment of a junction box in which the so called functional components like, for example, bypass diodes are arranged in the cover and are contacted with the current carrying components through applying the cover to the junction box is very advantageous for particular applications.

However, it has become apparent that certain production processes for solar modules facilitate or require even more efficient manufacturing methods also for the junction box.

When producing solar modules in a fully automated manner the junction box is typically supplied by vendors completely assembled. Preassembled units of this type are delivered to assembly lines in magazines. There the junction boxes are removed by assembly robots and attached at the solar modules.

### BRIEF SUMMARY OF THE INVENTION

Thus, it is an object of the invention to provide a preassembled junction box which can be produced with minimum complexity.

The object is achieved by a junction box with a housing forming an inner cavity including an end of a connecting conductor for outputting generated electrical energy, wherein the end of the connecting conductor is electrically connected with a bypass diode, and wherein a lead of the end of the connecting conductor that is included in the housing is provided with a lead end sleeve at which a contact arm of the bypass diode is directly arranged, and in particular with the characterizing features according to which a lead of an end of the connecting conductor included in the housing is provided with a lead end sleeve at which a contact arm of the bypass diode is directly arranged.

The essential advantage of arranging the bypass diode directly at the connecting conductor or at the lead end sleeve enveloping the connecting conductor essentially relates to simplifying assembly. The number of the assembly steps and the amount of the material used is significantly reduced over the prior art. Thus, production is configured more effectively and cost savings can be implemented.

In one embodiment it is provided that the lead end sleeve forms a tongue for receiving the contact arm of a bypass diode.

The tongue formed by the lead end sleeve facilitates automated assembly in as far as the contact arm of the bypass diode is applied to the tongue in a first step and thus assembled to be pre contacted with the lead end sleeve. Thus, the tongue facilitates subsequent soldering, welding or gluing.

The described embodiment can be refined further in that the tongue is arranged at a free end of the strand lead sleeve and configured as a shell.

The shell configuration of the tongue facilitates that the contact arm of the bypass diode contacts the lead end sleeve with substantially stable positioning.

An exemplary embodiment is characterized in that the lead end sleeve is provided with a groove for receiving the contact arm of the bypass diode. Thus, it is advantageous in particular when the groove is provided as a fully circumferential throat groove.

In particular introducing a circumferential throat groove has substantial production advantages. While the lead end jacket has to be arranged in a particular position within the junction box for the known embodiment with a tongue so that the contact arms of the bypass diode contact the tongue of the lead end jacket completely and safely, the contact arm of the bypass diode can always be correctly arranged in the throat groove irrespective of the alignment of the lead end sleeve in the embodiment with throat groove. An adjustment of the strand end sleeve through rotating the connecting conductor about its longitudinal axis in order to obtain a correct assembly position is therefore not required.

Thus, it is provided that the housing of the junction box includes a support for the bypass diode and/or the lead end sleeve.

Thus it is advantageous in particular that the support includes mechanical support devices for the bypass diode and/or the lead end sleeve.

Both recited embodiments advantageously facilitate arranging the connecting conductor with the lead end jacket through assembly tools in a stable position in the junction box. The same applies also for a position stable arrangement of the bypass diode in the junction box. The attachment of the contact arm at the lead end sleeve can be provided in a second process step.

Thus, the object of the invention is also achieved by a junction box with a contact arm of the bypass diode is directly connected at the lead of the connecting conductor. Additional advantageous embodiments are provided with the free end of the lead is configured as a tongue for receiving the contact arm of the bypass diode and/or a groove for receiving the contact arm of the bypass diode is formed into the free end of the lead.

It is a substantial advantage of the alternative solution where a contact arm of the bypass diode is directly connected at the lead of the connecting conductor that mounting a lead end jacket at the connecting conductor can be omitted. Depending on the desired embodiment the tongue or the throat groove is directly formed into the lead of the connecting conductor.

A tin coating that may be used for shape stabilization can be simultaneously used for a solder joint contact arm and connecting conductor.

### BRIEF DESCRIPTION OF THE DRAWINGS

The invention is subsequently described based on an embodiment with reference to figures wherein:

FIG. 1 illustrates a top view of a first embodiment of the junction box according to the invention;

FIG. 2 illustrates the junction box according to FIG. 1 in a perspective view;

FIG. 3 illustrates an end of a connection cable included in a junction box according to FIGS. 1 and 2;

FIG. 4 illustrates a top view of a junction box a according to the invention in a second embodiment;

FIG. 5 illustrates a perspective view of the junction box according to FIG. 4; and

FIG. 6 illustrates an end of a connection cable included in the junction box according to FIGS. 4 and 5.

### DETAILED DESCRIPTION OF THE INVENTION

The figures illustrate a junction box 10. The junction box 10 includes a housing 11 which forms an inner cavity 12.

Functional components like, for example, the illustrated bypass diode 13 which includes two contact arms 14 are arranged in the inner cavity 12.

Connecting conductors 15 are inserted from an outside into the inner cavity 12, wherein the connecting conductors are supported through safety bars 16 at the junction box 10. The end of the connecting conductor 15 included in the junction box 10 is stripped from its insulating jacket 17 so that the lead 18 is provided with a lead end sleeve 19. The contact arms 14 of the bypass diode 13 are respectively directly arranged at a lead end sleeve 19 of the connecting conductor 15 and secured, for example, through soldering, welding or gluing.

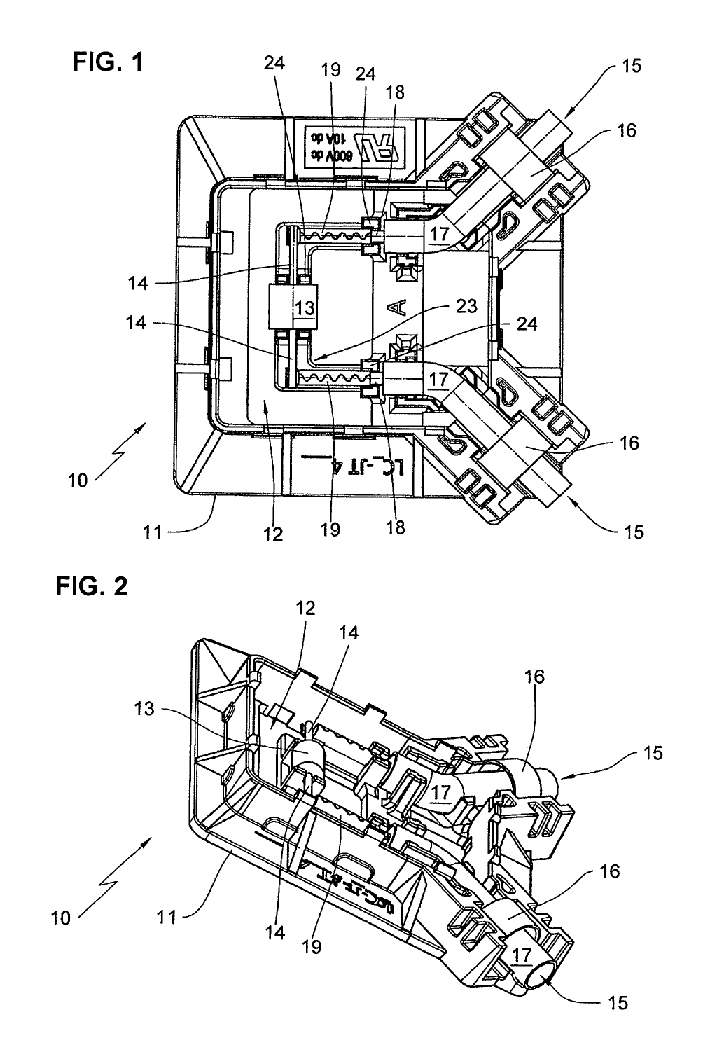

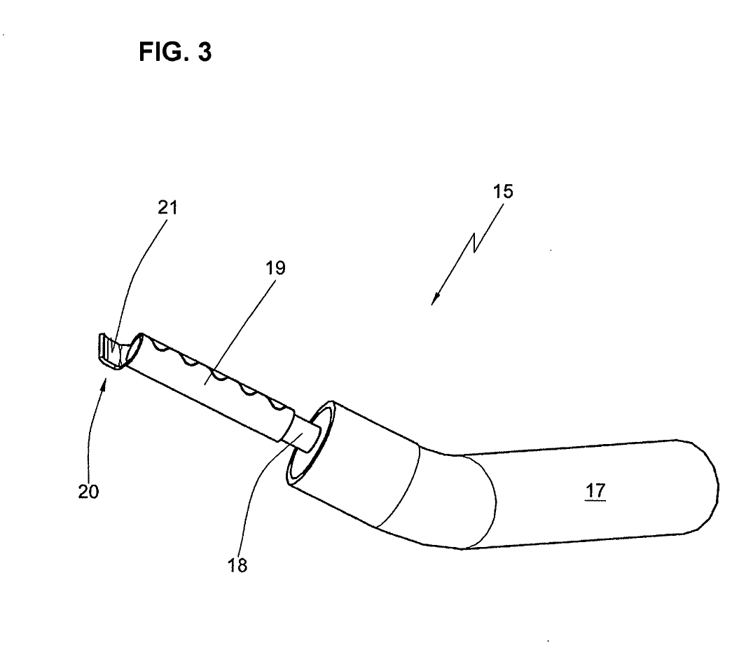

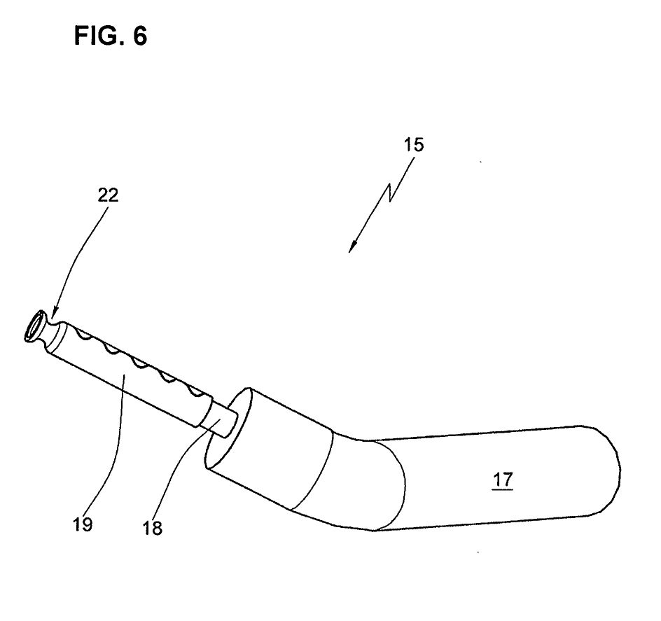

FIGS. 3 and 6 respectively illustrate the end of the connecting conductor 15 by itself which is respectively included in the junction box 10 according to FIGS. 1 and 2 or FIGS. 4 and 5. The strand 18 is enveloped by an insulating jacket 17 which was removed for clearing the lead 18 at the free end of the connecting conductor 15. The stripped section of the strand 18 is respectively enveloped by a lead end sleeve 19 which is advantageously crimped onto the lead 18.

The lead end sleeve 19 in FIG. 3 includes a tongue 20 which is formed approximately like a shell maintaining a particular bending radius. As evident from FIGS. 1, 2 and 3 the respective contact arm of the bypass diode 13 contacts the tongue 20. For this it is necessary that the contact surface 21 of the tongue 20 is aligned substantially parallel to the contact arm 14. The connecting conductor 17 is not freely rotatable about its longitudinal axis when inserted into the junction box 10, but has to be arranged in a defined position.

The essential advantage of the tongue 20 is its comparatively large contact surface 21 which is very well suited for attaching the contact arms 14 and provides a sufficient contact surface for good electrical transition from the bypass diode 13 to the connecting conductor 15.

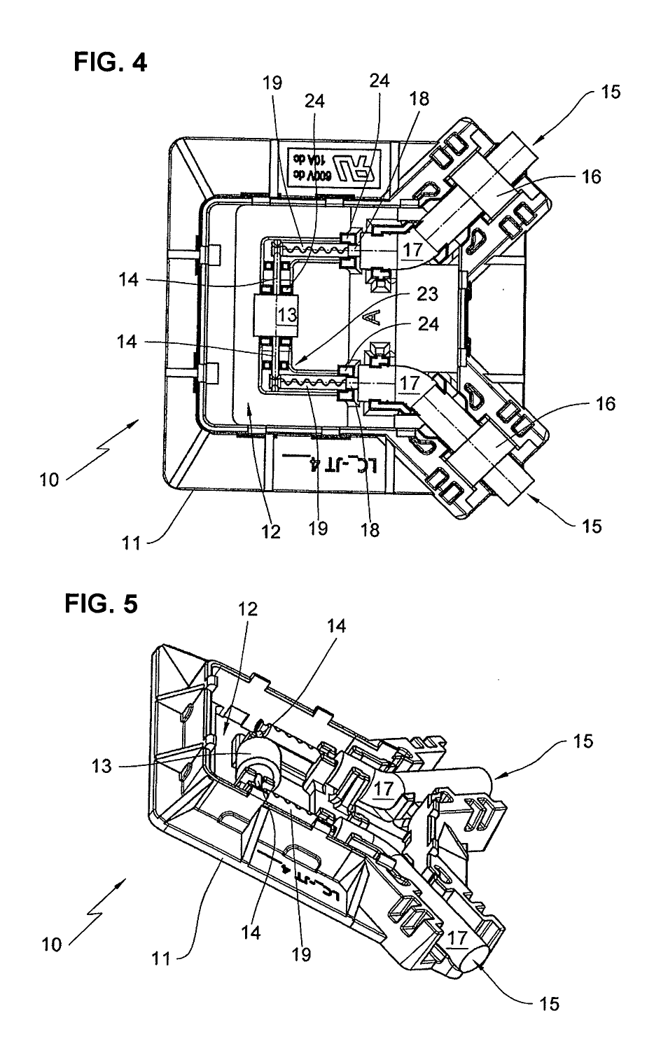

Differently from the illustration in FIG. 3 the lead end sleeve 19 in FIG. 6 includes a deviation from the illustration in FIG. 3 in that it has a circumferential throat groove 22 at its free end. In the illustrations of FIGS. 4 and 5 the lead end sleeve contacts the contact arm 14 of the bypass diode 13 from above which is different from the illustration in FIGS. 1 and 2. However, it is easily understandable that also on the other hand side the contact arms 14 can contact the lead end sleeve 19 in the throat groove 22 from above. Due to the rotation symmetry of the throat groove 22 no particular rotational orientation of the connecting conductor 15 needs to be maintained. No matter how the connecting conductor 15 is rotated about its longitudinal axis the contact surface between the throat groove 22 of the lead end sleeve 19 and the contact arm 14 of the bypass diode 13 is provided. This has substantial advantages for the production process since no particular orientation of the jacket end sleeve 19 has to be maintained.

The contact surface of the throat groove 22 that is smaller relative to the tongue 20 is compensated through attaching the contact arm 14 and the lead end sleeve 19 through a suitable electrically conductive material e.g. soldering tin.

Furthermore the support 23 is advantageous which is used for supporting lead end sleeves and the bypass diode 13. The support stabilizes the bypass diode 13 and the strand end jackets 19 for the assembly process and it is furthermore provided with mechanical support devices 24.

Supports 24 that are respectively arranged in pairs respectively receive a lead end sleeve 19 and a lead 18 between one another preferably through clamping and thus support the free end of the connecting conductor 15 in a defined assembly position. The bypass diode 13 is supported through support devices that are arranged in pairs which receive the contact arms 14 between one another. The support 23 is configured as a portion of the housing 11.

The embodiment of the invention is not illustrated in which the contact arms 14 of the bypass diode 13 are directly attached at the lead 18 of the connecting conductor 15.

Thus, it is advantageous to provide the lead 18 itself analogously to the embodiment according to FIGS. 1-3 with a tongue through deforming the strand 18. Alternatively the lead 18 can also be provided with a circumferential throat groove analogous to FIGS. 4 through 6 which is also achieved through respective deforming. The embodiment saves attaching the lead end jacket 19. The embodiment can be used in one piece leads 18 made form solid material and also for leads 18 which are made from plural strands. In the latter case it is advantageous when the respectively deformed lead 18 is mechanically stabilized through tinning.

A junction box with the free end of the lead is configured as a tongue for receiving the contact arm of the bypass diode can be characterized in that the tongue if formed like a shell.

A junction box with a groove for receiving the contact arm of the bypass diode is formed into the free end of the lead that can be characterized in that the groove is configured as a fully circumferential throat groove.

A junction box with a contact arm of the bypass diode is directly connected at the lead of the connecting conductor, and/or the free end of the lead is configured as a tongue for receiving the contact arm of the bypass diode and/or a groove for receiving the contact arm of the bypass diode is formed into the free end of the lead that can be characterized in that a form locking of the tongue or the groove is stabilized by tinning the lead 18 that includes plural strands.

### REFERENCE NUMERALS AND DESIGNATIONS

10 junction box
11 housing
12 inner cavity
13 bypass diode
14 contact arm
15 connecting conductor
16 safety bar
17 insulating jacket
18 lead
19 lead end sleeve
20 tongue
21 contact surface
22 throat groove
23 support
24 mechanical support devices

What is claimed is:

1. A junction box for a solar module, comprising:
a housing forming an inner cavity including an end of a connecting conductor for outputting generated electrical energy,
wherein the end of the connecting conductor is electrically connected with a bypass diode, and
wherein a lead of the end of the connecting conductor that is included in the housing is provided with a lead end sleeve at which a contact arm of the bypass diode is directly arranged.

2. The junction box according to claim 1, wherein the lead end sleeve forms a tongue for receiving the contact arm of the bypass diode.

3. The junction box according to claim 2, wherein the tongue is arranged at a free end of the lead end sleeve and configured as a shell.

4. The junction box according to claim 1, wherein the lead end sleeve is provided with a groove for receiving the contact arm of the bypass diode.

5. The junction box according to claim 4, wherein the groove is configured as a fully circumferential throat groove.

6. The junction box according to claim 1, wherein the housing of the junction box includes a support for the bypass diode or the lead end sleeve.

7. The junction box according to claim 6, wherein the support includes mechanical support devices for the bypass diode or the lead end sleeve.

8. The junction box according to claim 2, wherein the housing of the junction box includes a support for the bypass diode or the lead end sleeve.

9. The junction box according to claim 8, wherein the support includes mechanical support devices for the bypass diode or the lead end sleeve.

10. The junction box according to claim 3, wherein the housing of the junction box includes a support for the bypass diode or the lead end sleeve.

11. The junction box according to claim 10, wherein the support includes mechanical support devices for the bypass diode or the lead end sleeve.

12. The junction box according to claim 4, wherein the housing of the junction box includes a support for the bypass diode or the lead end sleeve.

13. The junction box according to claim 12, wherein the support includes mechanical support devices for the bypass diode or the lead end sleeve.

14. The junction box according to claim 5, wherein the housing of the junction box includes a support for the bypass diode or the lead end sleeve.

15. The junction box according to claim 14, wherein the support includes mechanical support devices for the bypass diode or the lead end sleeve.

16. The junction box according to claim 1, wherein a contact arm of the bypass diode is directly connected at the lead of the connecting conductor.

17. The junction box according to claim 16, wherein the free end of the lead is configured as a tongue for receiving the contact arm of the bypass diode.

18. The junction box according to claim 16, wherein a groove for receiving the contact arm of the bypass diode is formed into the free end of the lead.
